(19) United States
(12) Patent Application Publication
(10) Pub. No.: US 2005/0283604 A1
(43) Pub. Date: Dec. 22, 2005

(54) Security association configuration in virtual private networks

(75) Inventors: Yashodhan Deshpande, San Jose, CA (US); Ravi Voleti, Fremont, CA (US); Manohar Mahavadi, Fremont, CA (US)

Correspondence Address: David B. Ritchie;THELEN REID & PRIEST LLP, P.O. BOX 640640, SAN JOSE, CA, 95164-0640, US

(73) Assignee: IPolicy Networks, Inc., a Delaware corporation

(21) Appl. No.: 10/873,627

(22) Filed: Jun. 21, 2004

(51) Int. Cl. H04L 9/00

(52) U.S. Cl. 713/160

(57) ABSTRACT

A solution is provided which eliminates the limitation of a single rule for multiple security associations by providing granularity in the configuration of selector fields for better control of the number of security associations established. This may be accomplished by using a selector field added to each rule if one wants to utilize multiple security associations for the rule. The selector field may include a mask which can be used to determine which threads require a new security association and which can utilize an existing security association. This solution provides significant flexibility in configuring Virtual Private Network rules by enabling the administrator to select appropriate selector fields for clustering of traffic streams through a single security association.

### FIELD OF THE INVENTION

The present invention relates to the field of computer network security. More specifically, the present invention relates to the configuration of security associations in a computer network.

### BACKGROUND OF THE INVENTION

A virtual private network (VPN) is a wide area network that connects private subscribers (such as employees of the same company) together using the public Internet as a transport medium, while ensuring that their traffic is not readable by the Internet at large. All of the data is encrypted to prevent others from reading it, and authentication measures ensure that only messages from authorized VPN users can be received.

Internet Protocol Security (IPsec) is a standard for security on the Internet that is commonly used to implement VPNs. IPsec (and other VPN standards) utilizes security associations in creating VPNs. These security associations, also known as tunnels, are typically negotiated by the end nodes before traffic is secured.

A security policy in a VPN is typically implemented using a series of rules. Each rule corresponds to a particular security policy. Table 1 below illustrates examples of VPN policies. In this table, rule 1 is a simple single source single designation rule, rule 2 is an application specific rule, rule 3 is a subnet rule, and rule 4 is a remote user specific rule.

TABLE 1

| Rule- | | | | | | IPSEC |
|---|---|---|---|---|---|---|
| No | Source | Destination | Application | Direction | Action | Properties |
| 1. | 192.168.1.1 | 208.206.2.2 | Any | Any | IPSEC | Ipsec1 |
| 2. | 192.168.1.2 | 208.206.2.2 | HTTP | Any | IPSEC | Ipsec1 |
| 3. | 202.101.1/24 | 206.101.1/24 | Any | Any | IPSEC | Ipsec1 |
| 4. | UserGrp1 | HomeNet | Any | Inbound | IPSEC | Ipsec1 |

In all the above cases, a single tunnel would be established for each rule according to the selectors specified. The tunnel is used to secure all traffic which satisfies the configured rule specification and thus multiple traffic streams are protected using the same encryption/decryption keys and algorithm negotiated during security association establishment. In the context of this document, the term “traffic stream” refers to similar traffic traveling between any particular source-destination pair.

There are many situations, however, where each traffic stream between two tunnel termination points (VPN gateway nodes) requires separate keys for protection. In a complex network system, a separate VPN tunnel between two VPN gateway nodes may be needed for each combination of <source IP, remote IP, upper layer protocol, source port, destination port/application>, also called a tuple. Having unshared security associations for each combination of tuple would provide enhanced security between two tunnel termination points.

Typically, there are two ways by which every traffic stream between two tunnel terminating nodes can be protected by its own security association with a distinct encryption/decryption key. One method is to configure a different rule for each traffic stream, which then requires the negotiation of a security association with unique encryption/decryption keys. Another method is to configure a single rule such that security associations are automatically negotiated for each of the unique traffic streams. Both of these solutions, however, create scalability problems in large networks. The number of tunnels required is equal to the number of traffic streams, which can be quite plentiful in full-fledged networks. In addition to the increased memory and processing requirements on the gateways, this also ties up network bandwidth with unneeded negotiation packets for multiple tunnels.

What is needed is a solution that provides granularity in the configuration of security associations, thus allowing for better control of the number of security associations established.

### BRIEF DESCRIPTION

A solution is provided which eliminates the limitation of a single rule for multiple security associations by providing granularity in the configuration of selector fields for better control of the number of security associations established. This may be accomplished by using a selector field added to each rule if one wants to utilize multiple security associations for the rule. The selector field may include a mask which can be used to determine which threads require a new security association and which can utilize an existing security association. This solution provides significant flexibility in configuring Virtual Private Network rules by enabling the administrator to select appropriate selector fields for clustering of traffic streams through a single security association.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a flow diagram illustrating a method for configuring a security association in accordance with an embodiment of the present invention.

FIG. 2 is a flow diagram illustrating a method for calculating a hash value in accordance with an embodiment of the present invention.

FIG. 3 is a block diagram illustrating an apparatus for configuring a security association in accordance with an embodiment of the present invention.

FIG. 4 is a block diagram illustrating an apparatus for calculating a hash value in accordance with an embodiment of the present invention.

### DETAILED DESCRIPTION

Embodiments of the present invention are described herein in the context of a system of computers, servers, and software. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

The present invention eliminates the limitation of a single rule for multiple security associations by providing granularity in the configuration of selector fields for better control of the number of security associations established. This solution provides significant flexibility in configuring VPN rules by enabling the administrator to select appropriate selector fields for clustering of traffic streams through a single security association.

In an embodiment of the present invention, an additional attribute is added to each rule. This may be known as the selector attribute. Table 2 is an example of rules having this additional field.

TABLE 2

| Rule- | | | | | | IPSEC | MSA |
|---|---|---|---|---|---|---|---|
| No | Source | Destination | Application | Direction | Action | Properties | Selectors |
| 1. | 192.168.1.1 | 208.206.2.2 | Any | Any | IPSEC | Ipsec1 | Sel1 |
| 2. | 192.168.1.2 | 208.206.2.2 | HTTP | Any | IPSEC | Ipsec1 | None |
| 3. | 202.101.1.24 | 206.101.1.24 | Any | Any | IPSEC | Ipsec1 | Sel3 |
| 4. | UserGrp1 | HomeNet | Any | Inbound | IPSEC | Ipsec1 | Sel4 |

The selector field may contain a mask, the mask defining clusters of tunnels. Table 3 below is an example of a selector field in accordance with an embodiment of the present invention. In this embodiment, selectors for source IP, destination IP, source port, Upper Layer Protocol, and Destination Port/Application may be toggled. Referring back to Table 2, in Rule 1, if Upper Layer Protocol is selected as Yes in the selector field (see Table 3), then different tunnels may be established between 192.168.1.1 and 208.206.2.2 for TCP traffic and UDP traffic. In Rule 2, if none of the selectors are set, then the rule will simply behave as it would have originally. In Rule 3, if both the source IP and destination IP selectors are set as Yes, then different tunnels may be established for each IP address combination. In Rule 4, if the source IP selector is set as Yes, then each user in the user group may establish a unique tunnel. Thus, by adding the selector field to the rule, the user can configure the VPN gateway to create either a single tunnel for the rule subnet or a separate tunnel for each selector field.

TABLE 3

| Field | Selection |
|---|---|
| Source IP | Yes |
| Destination IP | No |
| Source Port | No |
| Upper Layer Protocol | Yes |
| Destination port/Application | No |

Since multiple security associations are established per single rule, there is a need to store the information for all the possible tunnels, and an efficient mechanism to search the entries of the information in such a way that the performance is not significantly affected and the ability for control of the number of security associations is not compromised. In an embodiment of the present invention, the data structures defined and the hashing method used contribute to these goals. A global hash table may be utilized and the hashing may be done based on all of the selector fields. The matching of the exact entry may be based on the actual selector mask, which is configured by the administrator.

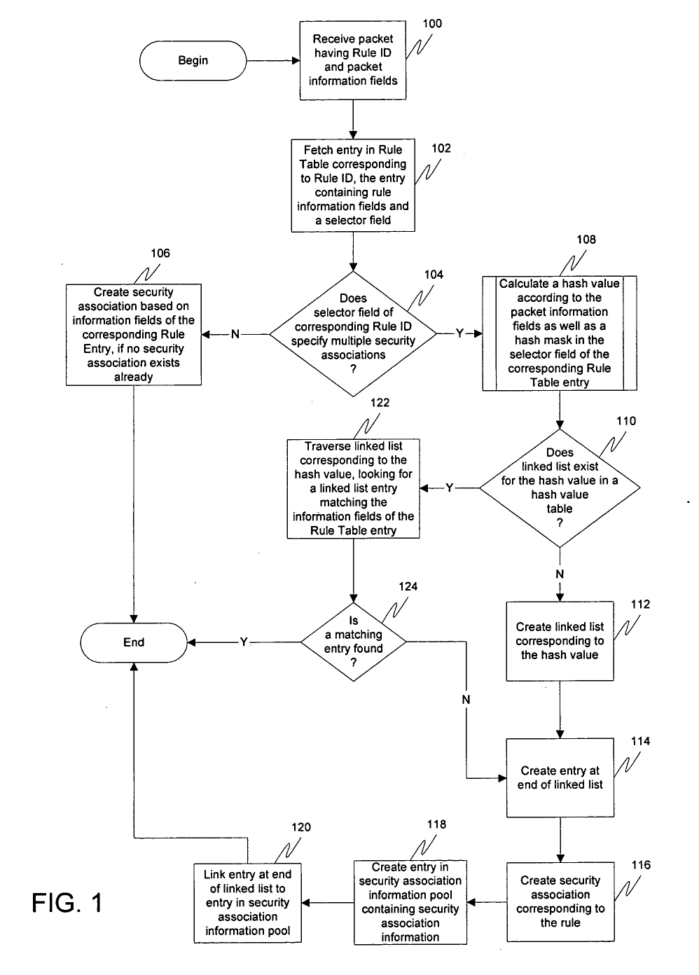

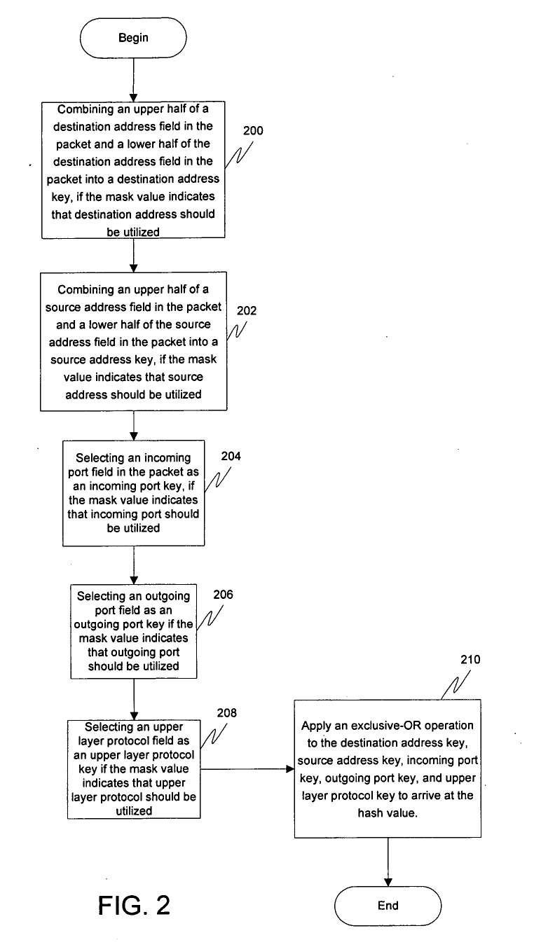

FIG. 1 is a flow diagram illustrating a method for configuring a security association in accordance with an embodiment of the present invention. This method may be executed each time a packet is received. At 100, the packet may be received, the packet containing a rule identifier and packet information fields. These packet information fields may include information such as the source address, destination address, upper layer protocol, destination port/application, and/or source port. At 102, a rule table entry corresponding to the rule identifier may be fetched. This entry may contain rule information fields and a selector field. The rule information fields may include information such as the source address, destination address, application, direction, action, and/or properties. The selector field may contain an indication of whether or not the selector field is in use (i.e., if multiple security associations are specified for this rule), as well as a hash mask. At 104, it may be determined whether or not the rule specifies a single security association or multiple security associations by examining the selector field. If it specifies a single security association, then all the required fields are found in the rule table entry itself. The process may simply proceed to 106, where the security association is created based on the information fields of the corresponding rule table entry if no security association exists already. If the selector field specifies multiple security associations, then at 108 a hash value may be calculated according to the packet information fields as well as the hash mask in the selector field. This is described in more detail in FIG. 2.

FIG. 2 is a flow diagram illustrating a method for calculating a hash value in accordance with an embodiment of the present invention. At 200, the upper half of a destination address field may be combined with the lower half of the destination address field into a destination address key, if the mask value indicates that destination address should be utilized. This may be accomplished by exclusive-ORing the upper half with the lower half. At 202, the upper half of a source address field may be combined with the lower half of the source address field into a source address key, if the mask value indicates that the source address should be utilized. This may be accomplished by exclusive-ORing the upper half with the lower half. At 204, a source port address may be selected as a source port key, if the mask value indicates that source port should be utilized. At 206, a destination port field may be selected as a destination port key, if the mask value indicates that destination port should be utilized. At 208, an upper layer protocol field may be selected as an upper layer protocol key if the mask value indicates that upper layer protocol should be utilized. At 210, an exclusive-OR operation may be applied to the destination address key, source address key, source port key, destination port key, and upper layer protocol key, to arrive at the hash value. If the mask value indicated that any of the fields would not be used, their respective keys would remain initialized at 0, thus not affecting the result of the exclusive-OR operation.

Returning to FIG. 1, at 110, a hash key table is referenced to find a linked list corresponding to the hash value. If no linked list is found corresponding to the hash value, then at 112 a linked list may be created corresponding to the hash value. At 114, an entry may be created at the end of the linked list. At 116, a security association corresponding to the rule may be created. At 118, an entry in a security association information pool may be created, the entry containing security association information. Then, at 120, the entry at the end of the linked list may be linked to the entry in the security association information pool. The linking may occur by adding a pointer to the entry in the security association information pool in the entry at the end of the linked list.

If, however, at 110 it was determined that a linked list does exist for the hash value in a hash value table, then at 122 the linked list may be traversed, looking for a linked list entry matching the information fields of the packet. Then, at 124, it may be determined if a match is found. If so, then the security association has already been set up for this stream, and the process may simply end. If not, however, then the process may proceed to 114, where an entry may be created at the end of the linked list and the process then continues on to 116 as before.

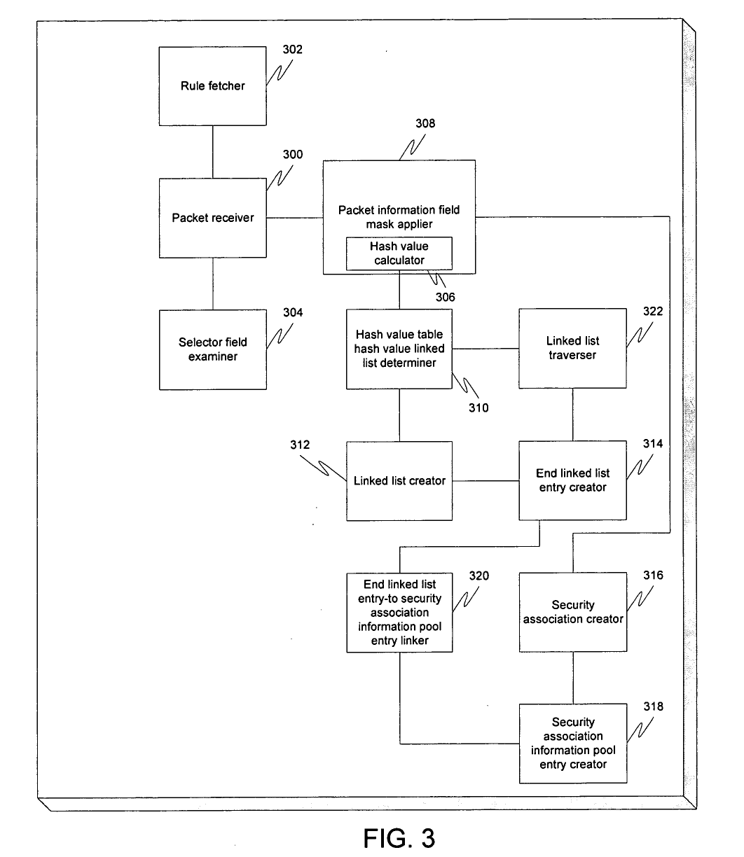

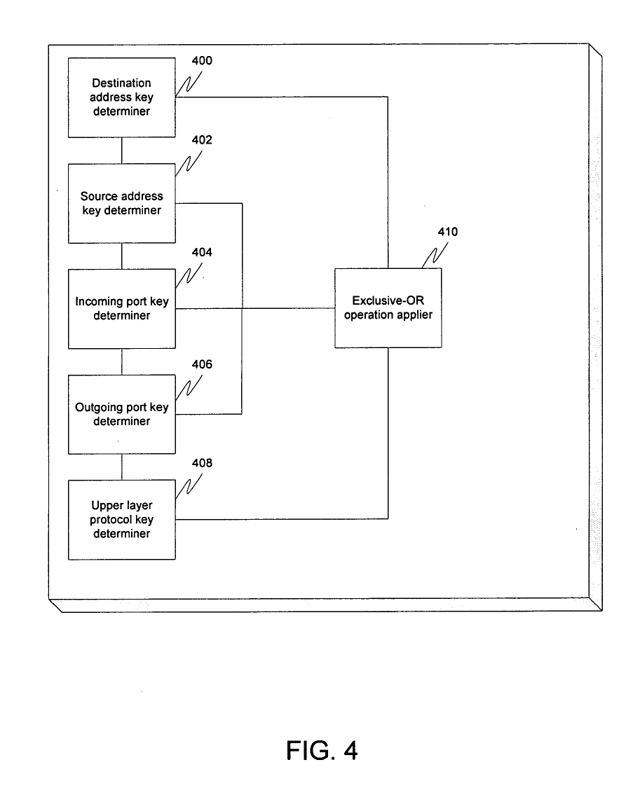

FIG. 3 is a block diagram illustrating an apparatus for configuring a security association in accordance with an embodiment of the present invention. This apparatus may be used each time a packet is received. A packet receiver 300 may receive the packet, the packet containing a rule identifier and packet information fields. These packet information fields may include information such as the source address, destination address, upper layer protocol, destination port/application, and/or source port. A rule fetcher 302 coupled to said packet receiver 300 may fetch a rule table entry corresponding to the rule identifier. This entry may contain rule information fields and a selector field. The rule information fields may include information such as the source address, destination address, application, direction, action, and/or properties. The selector field may contain an indication of whether or not the selector field is in use (i.e., if multiple security associations are specified for this rule), as well as a hash mask. A selector field examiner 304 coupled to the packet receiver 300 may determine whether or not the rule specifies a single security association or multiple security associations by examining the selector field. If it specifies a single security association, then all the required fields are found in the rule table entry itself. Then the security association is created based on the information fields of the corresponding rule table entry. If the selector field specifies multiple security associations, then a hash value calculator 306 in a packet information field mask applier 308 may calculate a hash value according to the packet information fields as well as the hash mask in the selector field. The hash value calculator is described in more detail in FIG. 4.

FIG. 4 is a block diagram illustrating an apparatus for calculating a hash value in accordance with an embodiment of the present invention. A destination address key determiner 400 may combine the upper half of a destination address field with the lower half of the destination address field into a destination address key, if the mask value indicates that destination address should be utilized. This may be accomplished by exclusive-ORing the upper half with the lower half. A source address key determiner 402 coupled to the destination address key determiner 400 may combine the upper half of a source address field with the lower half of the source address field into a source address key, if the mask value indicates that the source address should be utilized. This may be accomplished by exclusive-ORing the upper half with the lower half. A source port key determiner 404 coupled to the source address key determiner 402 may select a source port address as a source port key, if the mask value indicates that source port should be utilized. A destination port key determiner 406 coupled to the source port key determiner 404 may select a destination port field as a destination port key, if the mask value indicates that destination port should be utilized. An upper layer protocol key determiner 408 coupled to the destination port key determiner 406 may select an upper layer protocol field as an upper layer protocol key if the mask value indicates that upper layer protocol should be utilized. An exclusive-OR applier 410 coupled to the destination address key determiner 400, source address key determiner 402, source port key determiner 404, destination port key determiner 406, and the upper layer protocol key determiner 408 may apply an exclusive-OR operation to the destination address key, source address key, source port key, destination port key, and upper layer protocol key, to arrive at the hash value. If the mask value indicated that any of the fields would not be used, their respective keys would remain initialized at 0, thus not affecting the result of the exclusive-OR operation.

Returning to FIG. 3, a hash value table hash value linked list determiner 310 coupled to the hash value calculator 306 may reference a hash key table to find a linked list corresponding to the hash value. If no linked list is found corresponding to the hash value, then a linked list creator 312 coupled to the hash value table hash value linked list determiner 310 may create a linked list corresponding to the hash value. An end linked list entry creator 314 coupled to the linked list creator 312 may create an entry at the end of the linked list. A security association creator 316 coupled to the packet information field mask applier 308 may then create a security association corresponding to the rule, if one does not exist already. A security association information pool entry creator 318 coupled to the security association creator 316 may then create an entry in a security association information pool, the entry containing security association information. An end linked list entry-to-security association information pool entry linker 320 coupled to the security association information pool entry creator 318 and to the end linked list entry creator 314 may then link the entry at the end of the linked list to the entry in the security association information pool. The linking may occur by adding a pointer to the entry in the security association information pool in the entry at the end of the linked list.

If, however, it was determined that a linked list does exist for the hash value in a hash value table, then a linked list traverser 322 coupled to the hash value table hash value linked list determiner 310 and to the end linked list entry creator 314 may traverse the linked list, looking for a linked list entry matching the information fields of the packet. Then it may be determined if a match is found. If so, then the security association has already been set up for this stream, and the process may simply end. If not, however, then the process may proceed to using the end linked list entry creator 314 to create an entry at the end of the linked list and the process then continues with the subsequent components described earlier.

While the above discusses the invention in terms of linked lists and hash tables, one of ordinary skill in the art will recognize that alternative data structures could be used.

Normally, any hash table has a fixed set of keys on which the hash is calculated. The limitation in this approach is that if the keys change, then the hash table needs to be different. Thus, the present scenario would have required a hash table per rule. This would ordinarily increase the total memory requirement and additionally require that different methods be implemented to hash in each type of hash table. In an embodiment of the present invention, there is a global hash table for all the rules. Thus, the total memory requirement is fixed, which is more logical in terms of managing the resources in terms of total capacity of the system. Having a common hash for any type of selectors makes this possible. Thus, there is just one hash function and it selects the hash key depending on the selector mask.

This solution provides more granularity in the configuration of security associations, as the user has control over the selection of individual selectors.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

1. A method for configuring security associations in a virtual private network, the method comprising:
receiving a packet, said packet having packet information fields and referencing a rule, said rule having one or more rule information fields and a selector field, wherein said selector field contains a mask as to one or more of said packet information fields;
applying said mask to said packet information fields, producing a result; and
creating a security association for the packet if there are no entries corresponding to the result in a security association information pool.

2. The method of claim 1, wherein said referencing of said rule is a rule identifier stored in the packet.

3. The method of claim 2, further comprising:
retrieving a rule corresponding to the rule identifier from a data structure.

4. The method of claim 3, wherein said data structure is a rule table.

5. The method of claim 1, wherein said one or more packet information fields include a source address, destination address, upper layer protocol, destination port/application and/or source port.

6. The method of claim 1, wherein said rule information fields include source address, destination address, application, direction, action, and/or properties.

7. The method of claim 1, wherein said selector field includes an indication of whether or not the selector field is in use.

8. The method of claim 7, further comprising
examining the selector field to determine whether or not the rule specifies a single security association or multiple security associations; and
wherein said applying is only performed if said rule specifies multiple security associations.

9. The method of claim 1, wherein said applying includes calculating a hash value according to said packet information fields and said mask.

10. The method of claim 9, further comprising:
determining if a linked list exists in a hash value table for said hash value.

11. The method of claim 10, further comprising:
traversing said linked list corresponding to the hash value, looking for a linked list entry matching the rule information fields, if said linked list exists in a hash value table for said hash value.

12. The method of claim 10, further comprising:
creating a linked list corresponding to the hash value if said linked list does not exist in a hash value table to said hash value.

13. The method of claim 11, further comprising:
creating a linked list corresponding to the hash value if said linked list does not exist in a hash value table to said hash value.

14. The method of claim 13, further comprising:
creating an entry at the end of said linked list if it was determined that a linked list does not exist in a hash value table for the hash value or if no linked list entry matching the rule information fields is found during said traversing.

15. The method of claim 14, further comprising:
creating an entry in a security association information pool containing security association information according to the created security association, if it was determined that a linked list does not exist in a hash value table for the hash value or if no linked list entry matching the rule information fields is found during said traversing.

16. The method of claim 15, further comprising:
linking said entry at end of said linked list to said entry in said security association information pool if it was determined that a linked list does not exist in a hash value table for the hash value or if no linked list entry matching the rule information fields is found during said traversing.

17. The method of claim 9, wherein said calculating includes:
combining an upper half of a destination address field in said packet and a lower half of the destination address field in said packet into a destination address key, if the mask value indicates that destination address should be utilized;
combining an upper half of a source address field in said packet and a lower half of the source address field in said packet into a source address key, if the mask value indicates that source address should be utilized;
selecting a source port field in the packet as a source port key, if the mask value indicates that source port should be utilized;
selecting a destination port field as a destination port key if the mask value indicates that destination port should be utilized;
selecting an upper layer protocol field as an upper layer protocol key if the mask value indicates that upper layer protocol should be utilized; and
applying an exclusive-OR operation to said destination address key, said source address key, said source port key, said destination port key, and said upper layer protocol key to arrive at said hash value.

18. An apparatus for configuring security associations in a virtual private network, the apparatus comprising:
a packet receiver;
a packet information field mask applier coupled to said packet receiver; and
a security association creator coupled to said packet information field mask applier.

19. The apparatus of claim 18, further comprising:
a selector field examiner coupled to said packet receiver.

20. The apparatus of claim 18, wherein the packet information field mask applier includes a hash value calculator.

21. The apparatus of claim 20, further comprising:
a hash value table hash value linked list determiner coupled to said hash value calculator.

22. The apparatus of claim 21, further comprising:
a linked list traverser coupled to said hash value table hash value linked list determiner.

23. The apparatus of claim 21, further comprising:
a linked list creator coupled to said hash value table hash value linked list determiner.

24. The apparatus of claim 22, further comprising:
a linked list creator coupled to said hash value table hash value linked list determiner.

25. The apparatus of claim 24, further comprising an end linked list entry creator coupled to said linked list traverser and to said linked list creator.

26. The apparatus of claim 25, further comprising:
a security association information pool entry creator coupled to said end linked list entry creator and to said security association creator.

27. The apparatus of claim 26, further comprising:
an end linked list entry-to-security association information pool entry linker coupled to said security association information pool entry creator and to said end linked list entry creator.

28. The apparatus of claim 21, wherein said hash value calculator includes:
a destination address key determiner;
a source address key determiner coupled to said destination address key determiner;
a source port key determiner coupled to said source address key determiner;
a destination port key determiner coupled to said source port key determiner;
an upper layer protocol key determiner coupled to said destination port key determiner; and
an exclusive-OR operation applier coupled to said destination address key determiner, said source address key determiner, said source port key determiner, said destination port key determiner, and said upper layer protocol key determiner.

29. An apparatus for configuring security associations in a virtual private network, the apparatus comprising:
means for receiving a packet, said packet having packet information fields and referencing a rule, said rule having one or more rule information fields and a selector field, wherein said selector field contains a mask as to one or more of said packet information fields;
means for applying said mask to said packet information fields, producing a result; and
means for creating a security association for the packet if there are no entries corresponding to the result in a security association information pool.

30. The apparatus of claim 29, wherein said referencing of said rule is a rule identifier stored in the packet.

31. The apparatus of claim 29, further comprising:
means for retrieving a rule corresponding to the rule identifier from a data structure.

32. The apparatus of claim 31, wherein said data structure is a rule table.

33. The apparatus of claim 29, wherein said one or more packet information fields include a source address, destination address, upper layer protocol, destination port/application and/or source port.

34. The apparatus of claim 29, wherein said rule information fields include source address, destination address, application, direction, action, and/or properties.

35. The apparatus of claim 29, wherein said selector field includes an indication of whether or not the selector field is in use.

36. The apparatus of claim 35, further comprising
means for examining the selector field to determine whether or not the rule specifies a single security association or multiple security associations; and
wherein said applying is only performed if said rule specifies multiple security associations.

37. The apparatus of claim 36, wherein said means for applying includes means for calculating a hash value according to said packet information fields and said mask.

38. The apparatus of claim 37, further comprising:
means for determining if a linked list exists in a hash value table for said hash value.

39. The apparatus of claim 38, further comprising:
means for traversing said linked list corresponding to the hash value, looking for a linked list entry matching the rule information fields, if said linked list exists in a hash value table for said hash value.

40. The apparatus of claim 38, further comprising:
means for creating a linked list corresponding to the hash value if said linked list does not exist in a hash value table to said hash value.

41. The apparatus of claim 39, further comprising:
means for creating a linked list corresponding to the hash value if said linked list does not exist in a hash value table to said hash value.

42. The apparatus of claim 41, further comprising:
means for creating an entry at the end of said linked list if it was determined that a linked list does not exist in a hash value table for the hash value or if no linked list entry matching the rule information fields is found during said traversing.

43. The apparatus of claim 42, further comprising:
means for creating an entry in a security association information pool containing security association information according to the created security association, if it was determined that a linked list does not exist in a hash value table for the hash value or if no linked list entry matching the rule information fields is found during said traversing.

44. The apparatus of claim 43, further comprising:
means for linking said entry at end of said linked list to said entry in said security association information pool if it was determined that a linked list does not exist in a hash value table for the hash value or if no linked list entry matching the rule information fields is found during said traversing.

45. The apparatus of claim 37, wherein said means for calculating includes:
means for combining an upper half of a destination address field in said packet and a lower half of the destination address field in said packet into a destination address key, if the mask value indicates that destination address should be utilized;
means for combining an upper half of a source address field in said packet and a lower half of the source address field in said packet into a source address key, if the mask value indicates that source address should be utilized;
means for selecting a source port field in the packet as a source port key, if the mask value indicates that source port should be utilized;
means for selecting a destination port field as a destination port key if the mask value indicates that destination port should be utilized;
means for selecting an upper layer protocol field as an upper layer protocol key if the mask value indicates that upper layer protocol should be utilized;
means for applying an exclusive-OR operation to said destination address key, said source address key, said source port key, said destination port key, and said upper layer protocol key to arrive at said hash value.

46. A program storage device readable by a machine, tangibly embodying a program of instructions executable by the machine to perform a method for configuring security associations in a virtual private network, the method comprising:
receiving a packet, said packet having packet information fields and referencing a rule, said rule having one or more rule information fields and a selector field, wherein said selector field contains a mask as to one or more of said packet information fields;
applying said mask to said packet information fields, producing a result; and
creating a security association for the packet if there are no entries corresponding to the result in a security association information pool.
